(19) United States
(12) Patent Application Publication
(10) Pub. No.: US 2018/0023794 A1
(43) Pub. Date: Jan. 25, 2018

(54) Optical Engine Device

(71) Applicant: Nitride Material Inc., New Taipei City (TW)

(72) Inventor: Chin-Yao CHANG, New Taipei City (TW)

(21) Appl. No.: 15/252,588

(22) Filed: Aug. 31, 2016

(30) Foreign Application Priority Data
Jul. 22, 2016 (TW) 105211144

(51) Int. Cl. F21V 29/70; F21V 17/12; F21V 29/89; F21V 31/00; F21V 5/04

(52) U.S. Cl. CPC F21V 29/70; F21V 31/005; F21V 5/04; F21V 29/89; F21V 17/12; F21Y 2115/10

(57) ABSTRACT

An optical engine device is formed by a lamp base, a thermally conductive block, an LED lamp panel, a lens module and a fixing ring. The lamp base has a positioning opening, and after the LED lamp panel is installed to the thermally conductive block, the thermally conductive block may be embedded into the positioning opening, such that the thermally conductive block is exposed from the lamp base, and the heat generated by the LED lamp panel is conducted to the bottom of the lamp base by the thermally conductive block and dispersed in air to achieve the heat dissipation effect, and the thermally conductive block may be made of a material with a thermal conductivity corresponsive to the power of the LED lamp panel, so as to improve the heat dissipation effect.

### BACKGROUND OF THE INVENTION

### (a) Field of the Invention

The present invention relates to an optical engine device with a thermally conductive block embedded into the bottom of a lamp base, and the thermally conductive block is provided for quickly conducting the heat generated by an LED lamp panel to the exterior of the lamp base according to the requirement of heat dissipation.

### (b) Description of the Related Art

Light emitting diode (LED) with the advantages of low power consumption, efficient power saving, long service life, and small volume has become a mainstream of the illumination industry, and the LEDs are usually installed onto a lamp panel that is provided for electrically connecting illumination devices. However, the LED lamp panel generates a large amount of heat during its operation, and a traditional solution is to dissipate the heat generated by the LED lamp panel by a heat sink, and the conventional LED lamp panel is installed to the heat sink directly, and the heat sink is non-adjustable with respect to the power of the LED lamp panel. If the LED is switched to one of a larger power, the heat dissipation efficiency of the heat sink will be unable to satisfy the actual heat dissipation requirement anymore. Therefore, it is a main subject for related manufacturers to find a feasible solution and provide the best heat dissipation efficiency to cope with the power of the LED.

### SUMMARY OF THE INVENTION

In view of the aforementioned drawback of the prior art, it is a primary objective of the present invention to provide an optical engine device with a thermally conductive block that can be replaced to one with a corresponsive thermal conductivity according to the power of the LED lamp panel and can dissipate the generated heat to the exterior of the lamp base.

To achieve the aforementioned and other objectives, the present invention discloses an optical engine device comprising a lamp base, a thermally conductive block, an LED lamp panel, a lens module and a fixing ring, wherein the lamp base has a positioning opening formed thereon and provided for embedding the thermally conductive block, such that after the LED lamp panel and the thermally conductive block are engaged, the heat generated by the LED lamp panel can be conducted by the thermally conductive block to the exterior of the lamp base and dispersed in air, and the thermally conductive block may be made of a material with a thermal conductivity corresponsive to the power of the LED lamp panel for further improving the heat dissipation effect of the LED lamp panel.

### BRIEF DESCRIPTION OF THE FIGURES

FIG. 1 is a schematic view of the structure of the present invention;

FIGS. 2˜6 are schematic views of the assembly of the present invention;

FIG. 7 is a schematic view of a first preferred embodiment of the present invention;

FIG. 8 is another schematic view of the first preferred embodiment of the present invention;

FIG. 9 is a schematic view of a second preferred embodiment of the present invention;

FIG. 10 is a schematic view of a third preferred embodiment of the present invention; and

FIG. 11 is a schematic view of the assembly of the third preferred embodiment of the present invention.

### DETAILED DESCRIPTION OF THE PREFERRED EMBODIMENT

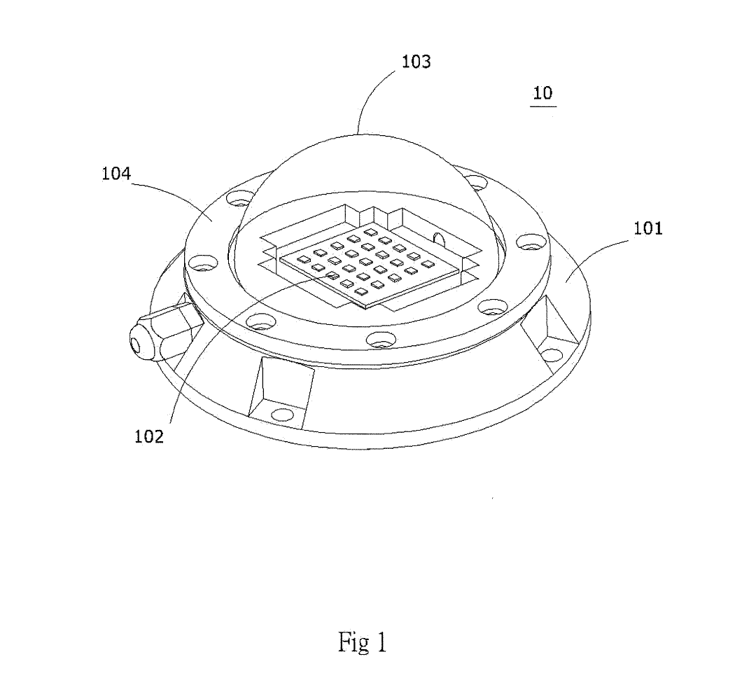

With reference to FIG. 1 for an optical engine device of the present invention, the optical engine device 10 comprises a lamp base 101, an LED lamp panel 102, a lens module 103 and a fixing ring 104, and the LED lamp panel 102, the lens module 103 and the fixing ring 104 are installed to the lamp base 101, and users may install the lamp base 101 of the optical engine device 10 at a desired installation location for the purpose of illumination. The lamp base 101 is integrally formed, and the interior of the lamp base 101 is provided for containing the LED lamp panel 102, and the LED lamp panel 102 comprises a circuit board, and at least one LED installed on the circuit board. After the LED lamp panel 102 is driven, the LED installed on the circuit board emits light. The lens module 103 is a convex lens, and the light generated by the LED lamp panel 102 may be projected to the outside through the lens module 103, wherein the fixing ring 104 is an annular ring. After the lamp base 101 and the fixing ring 104 are assembled, the components such as the LED lamp panel 102 and the lens module 103 are fixed to the lamp base 101.

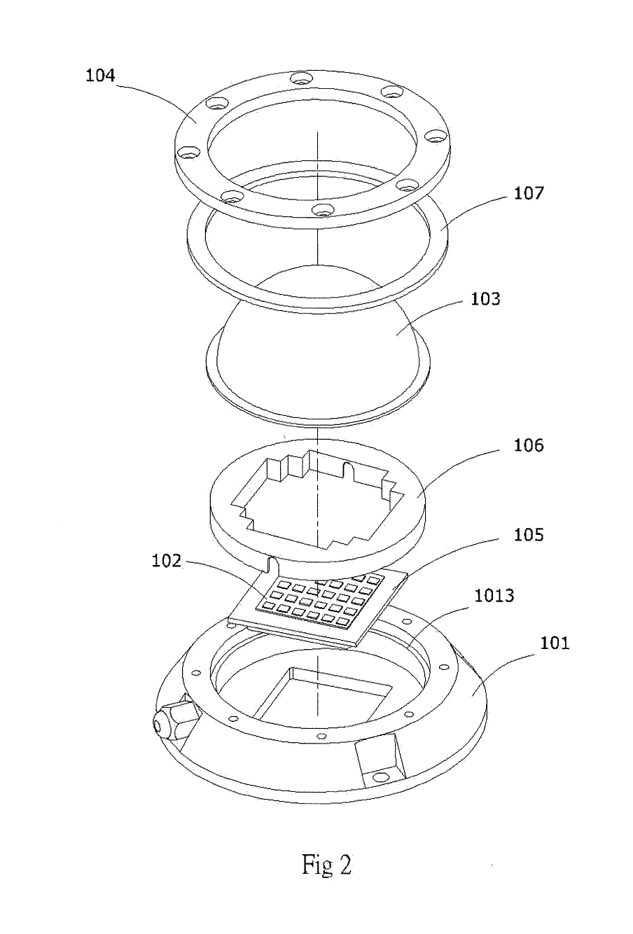

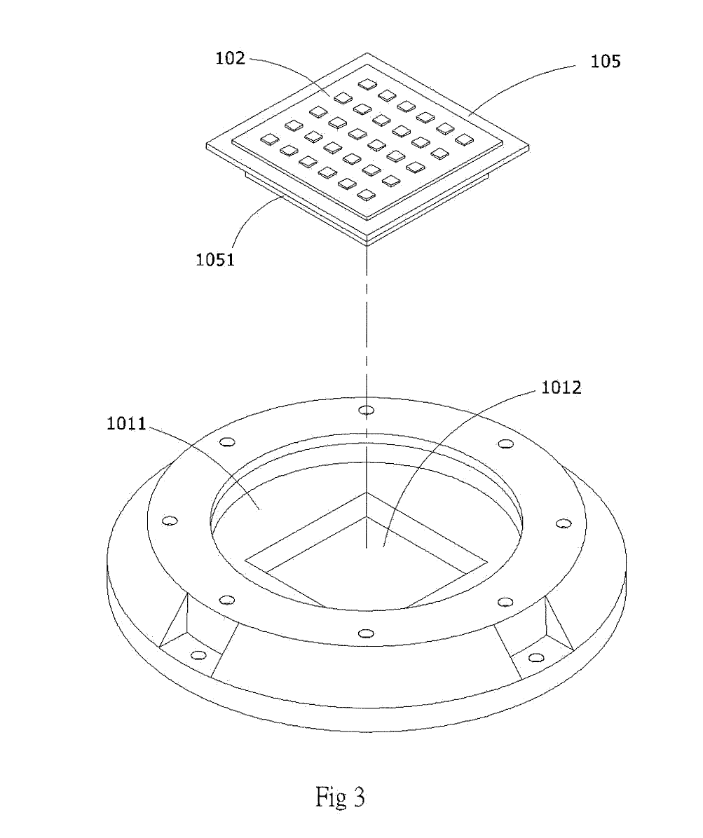

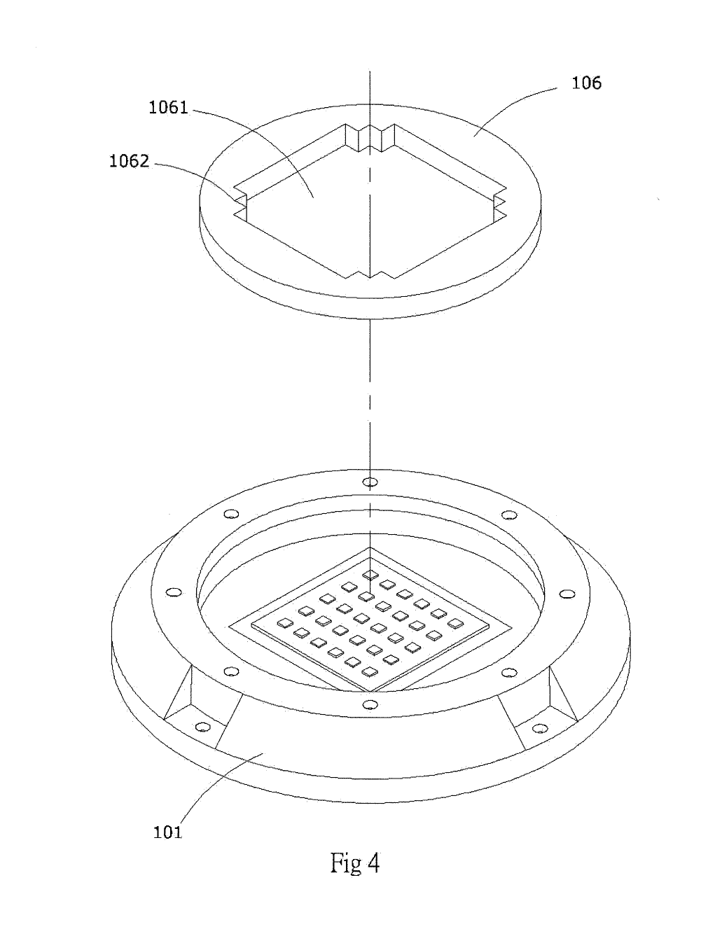

In FIG. 2, the optical engine device 10 further comprises a thermally conductive block 105, a mounting bracket 106 and a waterproof strip 107, and the thermally conductive block 105 is made of a metal with an excellent thermal conductivity, so that the thermally conductive block 105 has a good thermal conducting effect to conduct the heat generated by the LED lamp panel 102 to the outside of the lamp base 101 quickly, and the waterproof strip 107 is in the shape of a circular ring and provides a waterproof insulation effect to prevent liquid from permeating from the outside of the lamp base 101. In FIG. 3, the LED lamp panel 102 is installed to one side of the thermally conductive block 105, and a bump portion 1051 is formed and extended from the other side of the thermally conductive block 105, and an accommodating space 1011 is formed in the lamp base 101 and the thermally conductive block 105 is installed to the bottom of the accommodating space 1011, so that the bump portion 1051 of the thermally conductive block 105 may be embedded into a positioning opening 1012 of the lamp base 101, wherein the positioning opening 1012 is in form of a through hole, and after the bump portion 1051 is embedded into the positioning opening 1012, the bump portion 1051 is exposed from the lamp base 101 and contacted with air. In FIG. 4, when the thermally conductive block 105 is embedded, the mounting bracket 106 is installed in the accommodating space 1011, wherein an opening portion 1061 is formed at the mounting bracket 106, and the opening portion 1061 has an opening with a size corresponsive to the LED lamp panel 102, so that the light source generated by the LED lamp panel 102 can be projected to the outside through the opening portion 1061. In addition, a pressing portion 1062 is formed and extended from an inner edge of the opening portion 1061, and when the mounting bracket 106 is mounted to the top of the LED lamp panel 102, the pressing portion 1062 of the mounting bracket 106 presses at an edge of the LED lamp panel 102 or the thermally conductive block 105 to further limit and position the LED lamp panel 102 or the thermally conductive block 105. In FIG. 5, after the mounting bracket 106 is installed, the lens module 103 is placed in the accommodating space 1011, wherein a retaining wall 1013 is formed and extended from an inner edge of the accommodating space 1011 of the lamp base 101 (as shown in FIG. 2), and the retaining wall 1013 has a height slightly greater than the height of the LED lamp panel 102 installed in the accommodating space 1011. When the lens module 103 is installed in the accommodating space 1011, the lens module 103 is abutted by the retaining wall 1013 to maintain the lens module 103 at an appropriate height with respect to the LED lamp panel 102 (or slightly higher than the LED lamp panel 102). In FIG. 2, after the lens module 103 is installed, a waterproof strip 107 is installed to the accommodating space 1011, and the waterproof strip 107 is closely attached to the periphery of the lens module 103 to prevent liquids from permeating into the accommodating space 1011. In FIG. 6, the fixing ring 104 has at least one screw hole 1041, and after the waterproof strip 107 is installed, the fixing ring 104 can align each screw hole 1041 with the at least one corresponsive screw hole 1014 formed on the lamp base 101, and the screw holes 1041 are locked securely by a plurality of screws, so that the LED lamp panel 102, the lens module 103, the fixing ring 104, the thermally conductive block 105, the mounting bracket 106 and the waterproof strip 107 are fixed into the accommodating space 1011 of the lamp base 101.

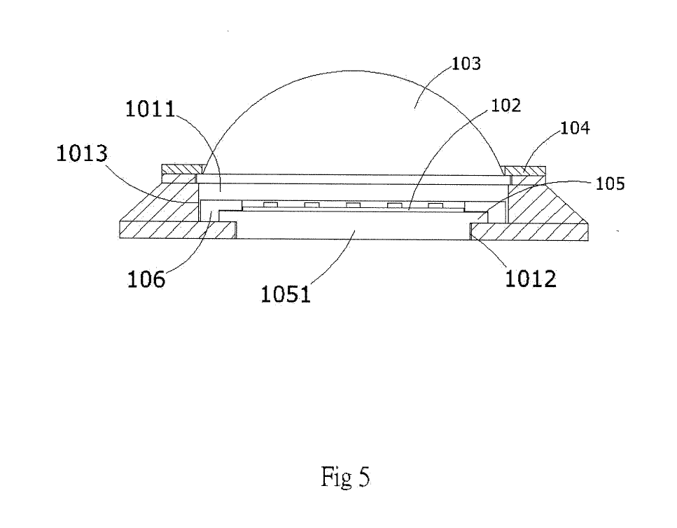

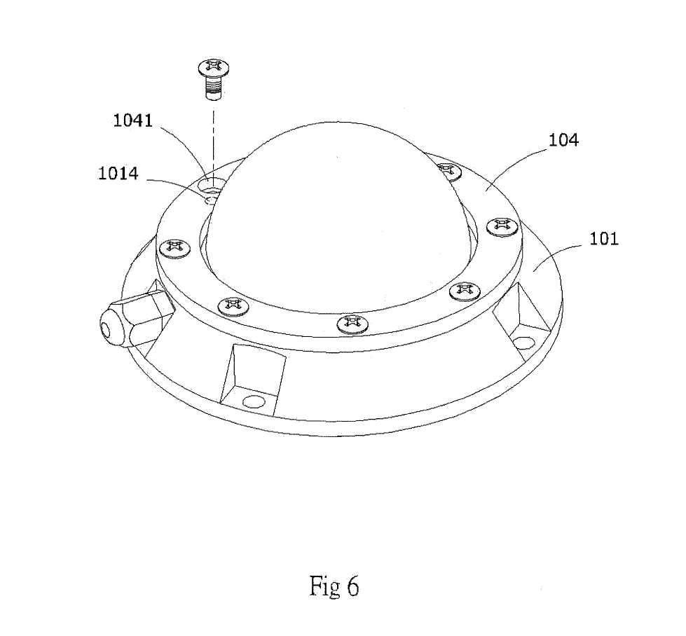

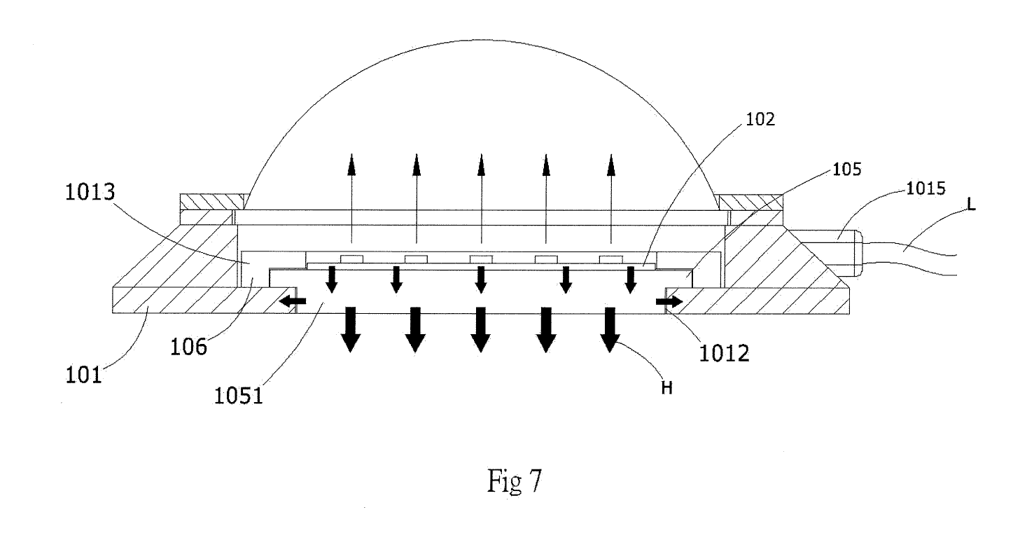

In FIG. 7, users may pass a power cable L through a wire hole 1015 of the lamp base 101 into the accommodating space 1011, wherein the wire hole 1015 of the lamp base 101 and at least one through hole of the mounting bracket 106 are configured to be corresponsive to each other, so that the power cable L can be passed through the through hole and electrically coupled to the LED lamp panel 102 to supply electric power to the LED lamp panel 102. After the LED lamp panel 102 is driven to emit light, the light may be projected from the lens module 103 to the outside to achieve the illumination effect. During the process of generating light by the LED lamp panel 102, the LED lamp panel 102 also generates heat H, and the thermally conductive block 105 in direct contact with the LED lamp panel 102 is capable of conducting the heat H from a contact surface to the bump portion 1051 and further dispersing the heat H to the air outside the lamp base 101 to achieve the heat dissipation effect. In addition, the users may choose a thermally conductive block 105 made of aluminum, copper, aluminum nitride with a thermal conductivity corresponsive to the power of the LED lamp panel 102, so that the LED lamp panel 102 provides the best thermal conduction effect.

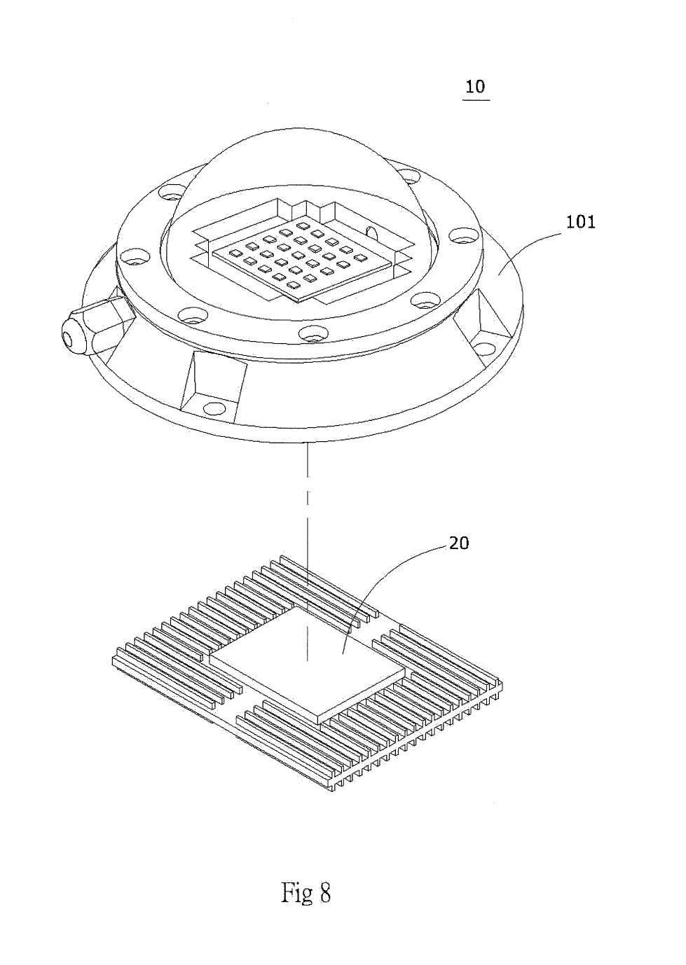

In FIG. 8, the optical engine device 10 further comprises a heat sink 20 for enhancing its heat dissipation effect, and the heat sink 20 is installed to the bottom of the lamp base 101, so that the heat sink 20 is in contact with the bump portion 1051 of the thermally conductive block 105, and the thermally conductive block 105 can conduct the heat to the heat sink 20, and the thermally conductive block 105 achieve a better heat dissipation effect.

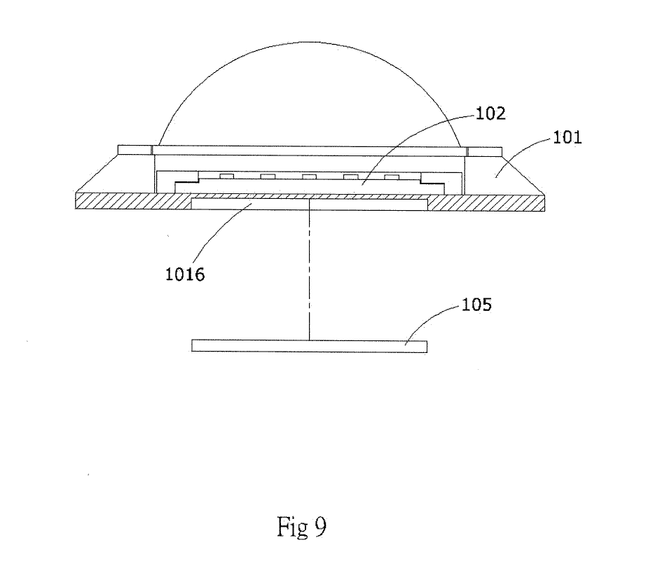

In FIG. 9, the thermally conductive block of the optical engine device 10 may also be fixed by an attaching method in addition to the aforementioned fixing method, and an assembly hole 1016 is formed at the bottom of the lamp base 101 and communicated with the lamp panel 102 disposed in the lamp base 101, and after the thermally conductive block 105 is embedded into the assembly hole 1016 from the exterior of the lamp base 101, the thermally conductive block 105 and the lamp panel 102 will be in contact with each other, so as to dissipate the heat generated by the lamp panel 102 to the outside through the thermally conductive block 105.

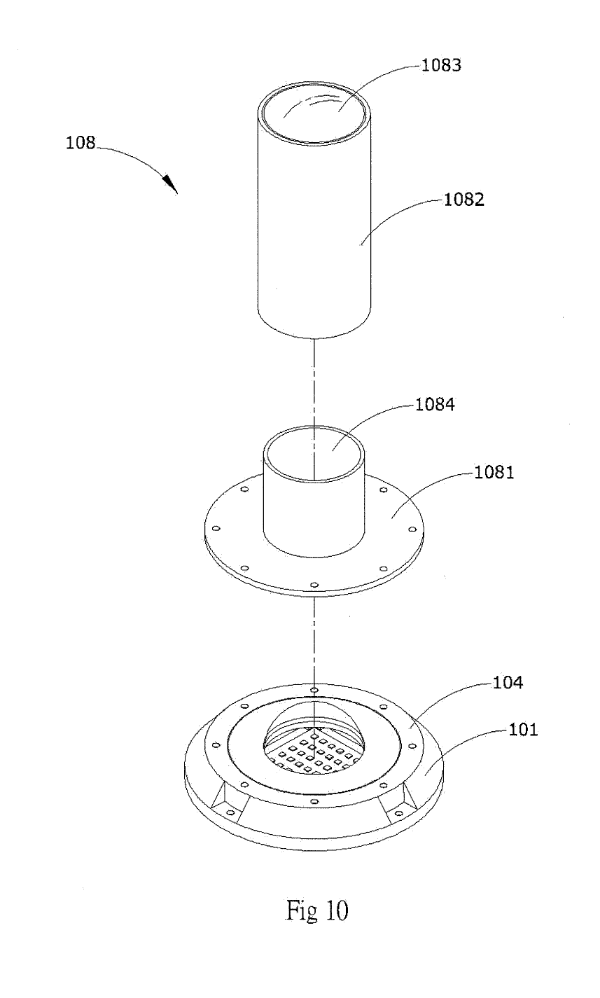

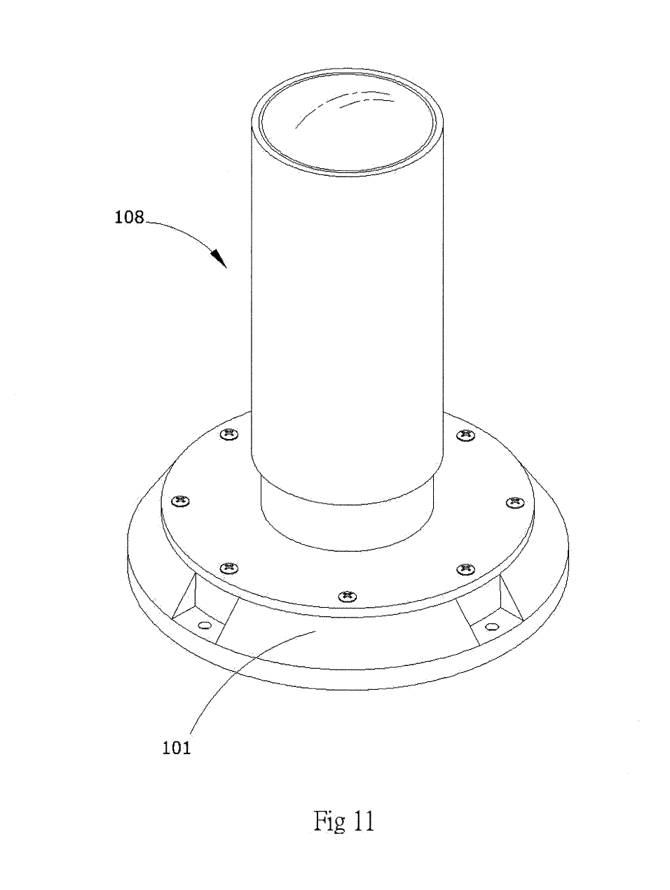

In FIG. 10, the optical engine device 10 further comprises a spotlight module 108, and the spotlight module 108 is formed by a support stand 1081, a support tube 1082 and a second lens 1083, and a hollow light output portion 1084 is formed and extended from the support stand 1081, and the support tube 1082 is a hollow tube, and the second lens 1083 has a light condensing effect. During assembling, the light output portion 1084 of the support stand 1081 is configured to be corresponsive to the LED lamp panel 102, and the support stand 1081 is locked to the fixing ring 104, and one of the ends of the support tube 1082 has a second lens 1083, and the other end of the support tube 1082 is sheathed on the light output portion 1084 of the support stand 1081 as shown in FIG. 11. When the LED lamp panel 102 projects the light to the outside, the light is concentrated at the support stand 1081 and in the support tube 1082, and the second lens 1083 projects the light to the outside, so as to achieve the light condensing effect.

In summation of the description above, the present invention provides an optical engine device capable of replacing a thermally conductive block with a thermal conductivity corresponsive to the power of the LED lamp panel and dissipating the generated heat to the outside of the lamp base.

1. An optical engine device, comprising:
a lamp base, having an accommodating space formed therein, and a positioning opening formed at the bottom of the accommodating space;
a thermally conductive block, having one side provided for installing an LED lamp panel, and a bump portion formed on the other side, and the bump portion being exposed from the lamp base after the bump portion of the thermally conductive block is embedded into the positioning opening of the accommodating space;
a mounting bracket, installed in the accommodating space, and having an opening portion formed thereon, and the LED lamp panel being configured to be corresponsive to the opening portion, and a pressing portion being formed and extended from an inner edge of the opening portion, such that the LED lamp panel is pressed and positioned by the pressing portion;
a lens module, installed in the accommodating space, and configured to be corresponsive to the LED lamp panel; and
a fixing ring, being an annular ring, and installed to the lamp base, so that components in the accommodating space are fixed into the lamp base.

2. The optical engine device according to claim 1, wherein the thermally conductive block is replaceable.

3. The optical engine device according to claim 1, further comprising a waterproof strip installed in the accommodating space of the lamp base and closely attached to the periphery of the lens module to define a waterproof insulation.

4. The optical engine device according to claim 1, further comprising a circular retaining wall formed and extended from the inner edge of the accommodating space of the lamp base, and the lens module is abutted by the retaining wall after the lens module is installed in the accommodating space.

5. The optical engine device according to claim 3, wherein the retaining wall has a height greater than the height of the LED lamp panel installed in the accommodating space.

6. The optical engine device according to claim 1, wherein the lamp base has a wire hole formed thereon, and the mounting bracket has at least one through hole formed thereon, and the wire hole of the lamp base and one of the through holes are configured to be corresponsive to a power cable, so that the power cable can be passed through the wire hole and the corresponsive through hole into the accommodating space and electrically coupled to the LED lamp panel.

7. The optical engine device according to claim 1, wherein the lamp base has a heat sink installed at the bottom of the lamp base, and the bump portion of the thermally conductive block and the heat sink are in contact with each other.

8. An optical engine device, comprising:
a lamp base, having an accommodating space formed therein, and an assembly hole formed at the bottom of the accommodating space;
a thermally conductive block, embedded into the assembly hole from the bottom of the lamp base, and an LED lamp panel being installed in the accommodating space, and contacted with the thermally conductive block; a mounting bracket, installed in the accommodating space, and having an opening portion formed thereon, and the LED lamp panel being configured to be corresponsive to the opening portion, and a pressing portion being formed and extended from an inner edge of the opening portion, such that the LED lamp panel is pressed and positioned by the pressing portion;
a lens module, installed in the accommodating space, and configured to be corresponsive to the LED lamp panel; and
a fixing ring, being an annular ring, and installed to the lamp base, so that components in the accommodating space are fixed into the lamp base.

9. The optical engine device according to claim 1, further comprising a spotlight module at least including a support stand, a support tube and a second lens, and the support stand being installed to the fixing ring, and the second lens being installed to an end of the support tube, and the other end of the support tube being sheathed on the support stand.

10. The optical engine device according to claim 8, further comprising a spotlight module at least including a support stand, a support tube and a second lens, and the support stand being installed to the fixing ring, and the second lens being installed to an end of the support tube, and the other end of the support tube being sheathed on the support stand.
